(19) United States
(12) Patent Application Publication
(10) Pub. No.: US 2004/0091345 A1
(43) Pub. Date: May 13, 2004

(54) Rear loader collection vehicle with detachable container

(76) Inventors: Gary Flerchinger, Hixson, TN (US); Mark A. Keller, Valley Head, AL (US); Bobby McKinney, Ft. Payne, AL (US); Henry M. Hund, Cedar Bluff, AL (US); Marcel G. Stragier, Scottsdale, AZ (US)

Correspondence Address: David J. Hill, Chambliss, Bahner & Stophel, P.C., 1000 Tallan Building, Two Union Square, Chattanooga, TN, 37402, US

(21) Appl. No.: 10/622,530

(22) Filed: Jul. 18, 2003

Related U.S. Application Data
(60) Provisional application No. 60/399,942, filed on Jul. 30, 2002.

(51) Int. Cl. B65F 3/00

(52) U.S. Cl. 414/525.2

(57) ABSTRACT

A refuse collection vehicle includes a chassis and a storage container that is detachably mounted on the chassis. The storage container has a rear wall with an opening therein and a sweep panel that is pivotally mounted in the rear wall. The sweep panel is movable between an open position which exposes the opening in the rear wall of the container and a closed position which covers the opening in the rear wall of the container. The refuse collection vehicle also includes a rear tailgate assembly that is pivotally mounted to the chassis. The tailgate assembly has a hopper which is adapted to receive refuse and a packer assembly which is adapted to move refuse from the hopper of the tailgate assembly to the opening in the rear wall of the storage container when the sweep panel of the storage container is in the open position. The sweep panel and the tailgate assembly are arranged and configured so as to minimize the spilling of refuse from the opening of the storage container into the hopper as the sweep panel is moved from the open position to the closed position.

### CROSS REFERENCE TO RELATED APPLICATION

This application claims the benefit of U.S. Provisional Application No. 60/399,942, which was filed on Jul. 30, 2002.

### FIELD OF THE INVENTION

This invention relates generally to a rear-loading refuse collection vehicle. More particularly, the invention relates to such a collection vehicle in which a storage container for refuse may be detachably mounted on the vehicle and removed therefrom. In a preferred embodiment of the invention, the detachable storage container generally has the dimensions of a standard intermodal shipping container.

### BACKGROUND AND DESCRIPTION OF THE PRIOR ART

Several different types of vehicles are commonly used for collection of household and commercial refuse. Some types of refuse collection vehicles are rear-loading, in which a packer mechanism is adapted to move refuse deposited in a hopper that is a part of the tailgate assembly into a storage compartment that is permanently mounted on the vehicle. Other types of refuse collection vehicles are front-loading or side-loading. It is also known to provide a collection vehicle in which a storage compartment is detachably mounted on the vehicle. Such vehicles are described in U.S. Pat. No. 3,370,525 of Bowles, U.S. Pat. No. 4,934,896 of Quinto, U.S. Pat. No. 5,562,390 of Christenson, U.S. Pat. No. 5,725,350 of Christenson and U.S. Pat. No. 5,938,393 of Georg.

In addition, U.S. Pat. No. 3,365,087 of Roedel et al. describes a rear loading vehicle with a detachably mounted storage compartment having a sloped rear wall that is provided with a hinged door that may be opened to provide access for deposit and compaction of refuse through the door opening. U.S. Pat. No. 3,380,600 of Klanner et al. describes a rear loading vehicle with a detachably mounted storage compartment and a tailgate assembly that includes support arms that are pivotally mounted to the vehicle in front of the removable storage compartment. U.S. Pat. No. 3,817,415 of Lewis describes a rear loading vehicle with a detachably mounted storage compartment and a detachably mounted tailgate assembly. All of these rear loading vehicles with detachably mounted storage compartments have a number of disadvantages. The storage compartments of the Roedel and Klanner vehicles have no means other than sloping rear walls to prevent compacted trash from rebounding or otherwise spilling out of the storage compartment when the packing mechanisms are removed therefrom. Furthermore, the Roedel and Klanner vehicles are not susceptible to use with standardized storage containers. In addition, operation of the Klanner vehicle requires the tailgate assembly to be moved above the container and the container dragged from beneath the tailgate assembly in order to remove the container from the vehicle. Although the Lewis vehicle may be used with a standardized container, its rear loader assembly must be completely disengaged from the vehicle and mounted on a support stand before the container can be removed.

Standard-sized containers (sometimes referred to as intermodal containers because many of them can be carried by various modes of transport) are widely used for transport and temporary storage of various products. Such containers include a container enclosure that is mounted within a standardized container frame which is adapted for stacking with other similar containers and (usually) for shipment by rail, truck or ship. The most common containers that are hauled by truck are 10 or 20 feet long, 8 feet wide and 8.5 feet high. Various other sizes are also in use. In order to be commercially successful, containers for intermodal shipping must be designed and built to internationally recognized standards such as those issued by the United Nations, the International Standards Organization (ISO) and the Association of American Railroads (AAR). These organizations promulgate standards for such containers relating to all facets of handling and carriage, including, among other things, strength, size, weight and materials used in the construction of the container. Applicable standards for intermodal shipping containers such as are described herein include ISO 1496/IV, AAR M-930, the United Nations' Council for Safe Containers (CSC) and Customs/TIR.

It would be desirable if a rear-loader refuse collection vehicle could be developed that could be used to store and compact refuse in a standardized removable storage container. It would also be desirable if such a vehicle could be developed that would not require the removal of the tailgate assembly or any complicated removal procedure for moving the container off of the vehicle. It would also be desirable if such a vehicle could be developed that could be operated in such a way that there would be little risk of compacted refuse rebounding or otherwise spilling out of the container.

### ADVANTAGES OF THE INVENTION

Among the advantages of the invention is that it allows for use of a removable container from a rear loading refuse collection vehicle with minimal modification of the container components. Another advantage of the invention is that it allows for removal of a storage container from the vehicle without requiring removal of the tailgate assembly from the vehicle. Still another advantage of the invention is that it does not require a complicated procedure or mechanism for moving the container off of the vehicle. Yet another advantage of the invention is that a rear loading vehicle so equipped may be operated in such a way that there is little risk of compacted refuse rebounding or otherwise spilling out of the container.

Additional objects and advantages of this invention will become apparent from an examination of the drawings and the ensuing description.

### EXPLANATION OF TECHNICAL TERMS

As used herein, the term “actuator” refers to a device that imparts linear or rotational motion to a component. The term “actuator” thus includes hydraulic actuators or cylinders, pneumatic actuators, motors, motorized drives, levers, springs, gear systems and combinations thereof.

As used herein, the term “hopper” refers to that portion of the tailgate assembly of a rear loading refuse collection vehicle into which refuse may be deposited.

As used herein, the term “front”, when used in reference to a vehicle, refers to the end of the vehicle where the cab is located. When used in reference to a container that is mounted or mountable on a vehicle, the term “front” refers to the end of the container nearest the cab of the vehicle when the container is mounted thereon.

As used herein, the term “rear”, when used in reference to a vehicle (or to a container that is mounted or mountable on a vehicle), refers to the end of the vehicle (or the container) opposite the front end.

### SUMMARY OF THE INVENTION

The invention comprises a rear loading refuse collection vehicle having a rear tailgate assembly and a detachably mounted container having a rear wall which is provided with an opening and a sweep panel mounted over the opening. The sweep panel may be moved between an open position which exposes the opening and a closed position which covers the opening. Opening of the sweep panel provides a path to the storage container for refuse material that is deposited in the hopper of the tailgate assembly of the vehicle. A packer moves the refuse material from the hopper to the opening in the rear wall of the container. The sweep panel and the tailgate assembly are arranged and configured so as to minimize the spilling of refuse from the opening of the storage container into the hopper as the sweep panel is moved from the open position to the closed position.

In order to facilitate an understanding of the invention, the preferred embodiments of the invention are illustrated in the drawings, and a detailed description thereof follows. It is not intended, however, that the invention be limited to the particular embodiments described or to use in connection with the apparatus illustrated herein. Various modifications and alternative embodiments such as would ordinarily occur to one skilled in the art to which the invention relates are also contemplated and included within the scope of the invention described and claimed herein.

### BRIEF DESCRIPTION OF THE DRAWINGS

The presently preferred embodiments of the invention are illustrated in the accompanying drawings, in which like reference numerals represent like parts throughout, and in which:

FIG. 1 is a rear perspective view of a preferred rear loading refuse collection vehicle constructed according to the invention, with the preferred tailgate assembly shown in partial section.

FIG. 2 is a rear perspective view of the preferred tailgate assembly of the vehicle of FIG. 1.

FIG. 3 is a front perspective view of the removable container that is a part of the preferred embodiment of the invention illustrated in FIG. 1.

FIG. 4 is a rear perspective view of the removable container that is a part of the preferred embodiment of the invention illustrated in FIG. 1.

FIG. 5 is a rear perspective view of the preferred vehicle of FIG. 1, with the tailgate assembly removed and the container raised above the chassis of the vehicle.

FIG. 6 is a front perspective view of the preferred vehicle of FIG. 1, showing the tailgate assembly tilted back from the container to permit easy removal of the container from the vehicle.

FIG. 7 is a front perspective view of the preferred embodiment of the vehicle illustrated in FIGS. 1, 5 and 6, with the container removed.

FIG. 8 is a front perspective view of the preferred embodiment of the vehicle illustrated in FIGS. 1 and 5-7, showing the tailgate assembly tilted forward for travel without a container mounted on the chassis.

FIG. 9 is a front perspective view of an alternative embodiment of the vehicle illustrated in FIGS. 1 and 5-8, showing an alternative tailgate assembly that may be tilted backward for travel without a container mounted on the chassis.

FIG. 10 is a side view of the preferred tailgate assembly of the embodiment of the invention illustrated in FIGS. 1, 2 and 5-8.

FIG. 11 is a front perspective cut-away view of the preferred tailgate assembly and container showing the sweep panel of the container in the open position.

FIG. 12 is a front perspective cut-away view of the preferred tailgate assembly and container showing the sweep panel of the container in the closed position.

### DESCRIPTION OF THE PREFERRED EMBODIMENTS OF THE INVENTION

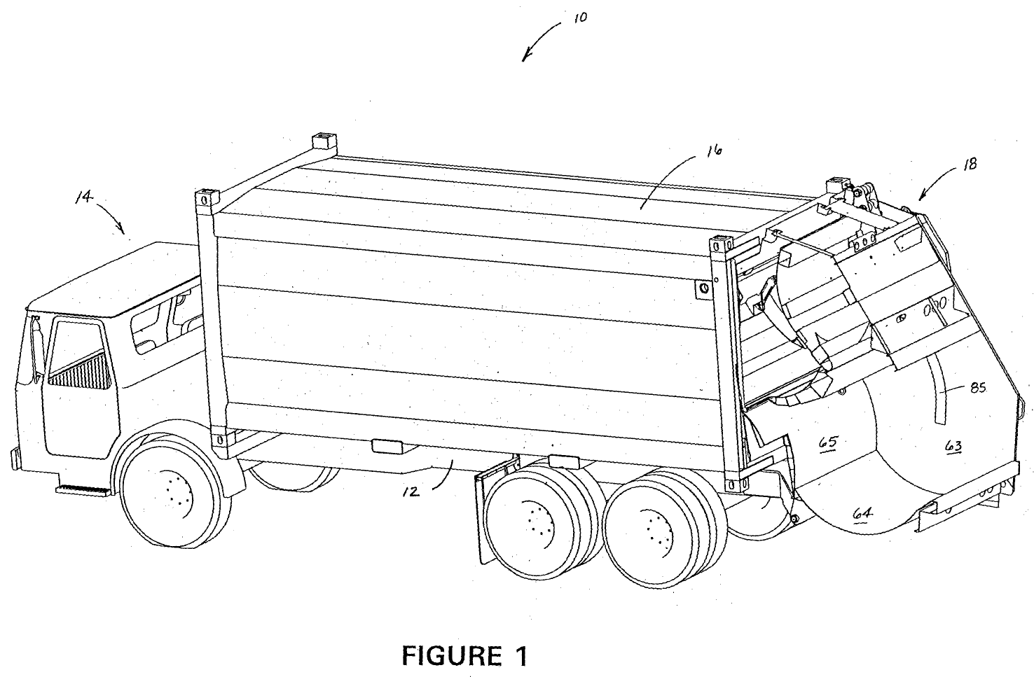

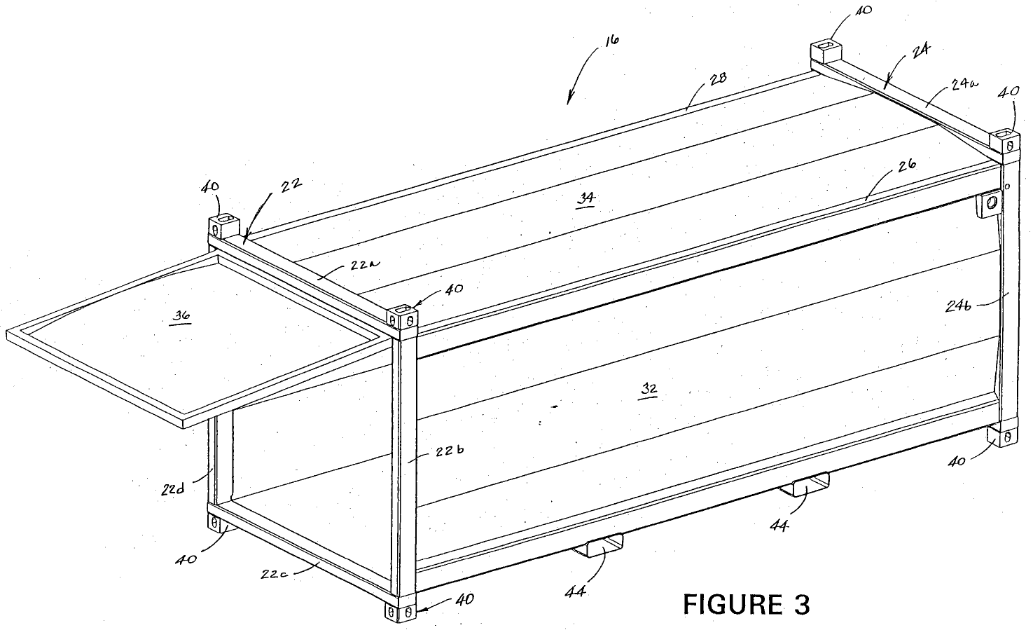

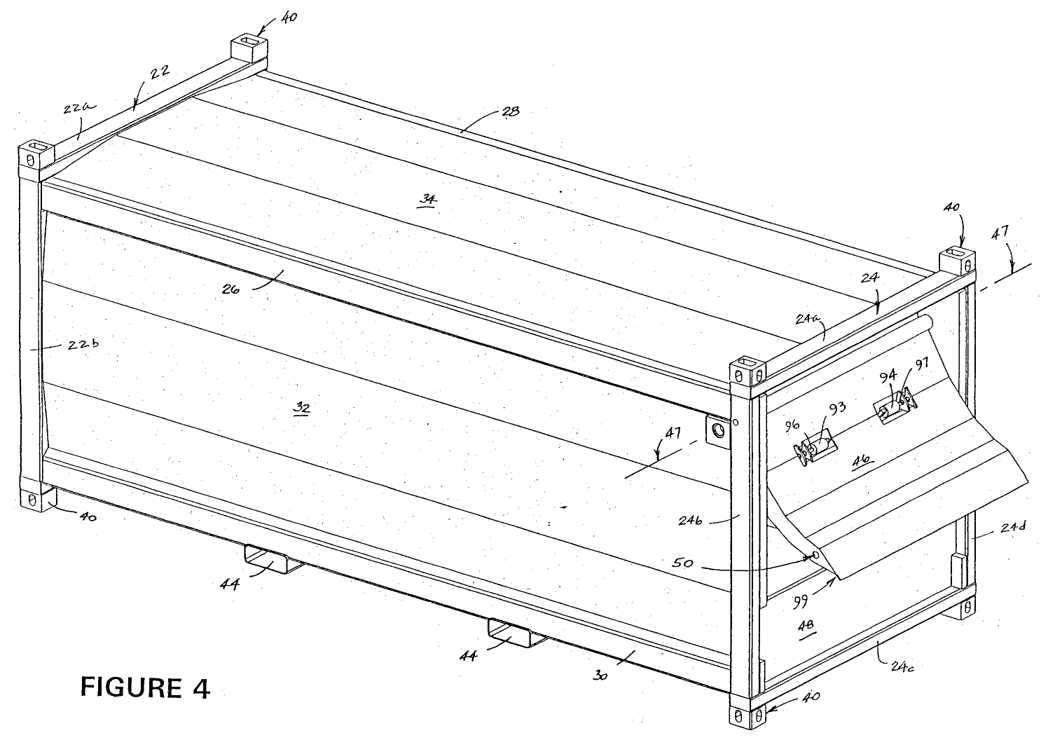

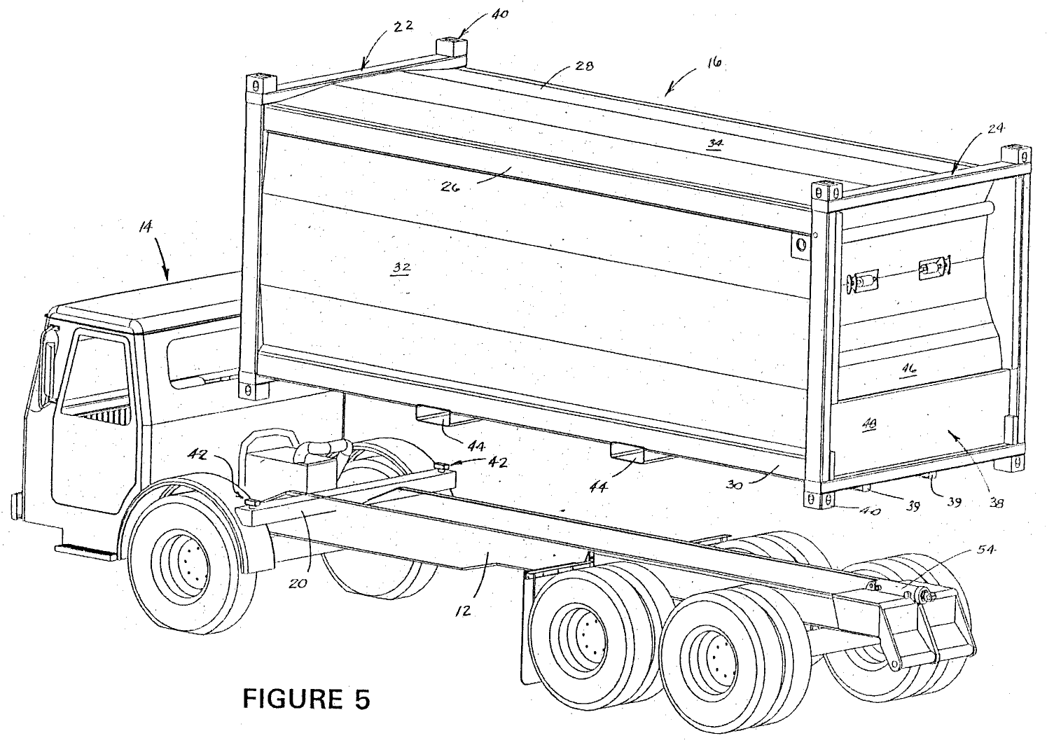

As shown in FIG. 1, preferred vehicle 10 includes chassis 12, cab 14, container 16 and tailgate assembly 18. The chassis includes at least one cross-member 20 (best shown in FIG. 5) for supporting a container of a particular length at or near its front end, and may include a similar cross-member (not shown) for supporting the container at or near its rear end. The chassis may also include additional cross-members (not shown) for supporting containers of different lengths. As shown in FIGS. 1 and 3-6, preferred container 16 includes a supporting frame having a pair of generally rectangular end pieces 22 and 24, each of which is comprised of four interconnecting frame components 22a, 22b, 22c and 22d, and 24a, 24b, 24c and 24d respectively (FIGS. 3 and 4). End pieces 22 and 24 are preferably connected by a pair of top rails 26 and 28 and a pair of bottom rails (only one of which, bottom rail 30, is shown in the drawings). As shown in FIGS. 3 and 4, in the preferred embodiment of the invention, one of each pair of rails is located on either side of the container body; however, in an alternative embodiment (not shown), the top rails may be omitted. The container body is comprised of a pair of container sidewalls (only one of which, sidewall 32 is shown), top wall 34, a bottom wall (not shown), front wall 36 and rear wall 38. One or more bottom rails 39 (FIG. 5) may be provided to reinforce the bottom of the container. The side rails, bottom rails and frame components of the end pieces are preferably comprised of formed channels or tubing having a square or rectangular cross-section, and the walls are preferably comprised of steel or aluminum sheet. At the corners of end pieces 22 and 24 are located corner castings 40, which are adapted to receive locks 42, which are located at the ends of the cross-members 20 and adapted to secure the container to the chassis. The corner castings may also be employed in lifting and transporting the container. In addition, the container may be lifted by a fork lift using lift channels 44.

As shown in FIG. 3, front wall 36 of preferred container 16 is hinged at the top so that it may swing open to allow for removal of refuse therefrom, as by, for example, tilting the container. The bottom of front wall 36 is also preferably provided with a sealing mechanism to seal against liquids (not shown) and locking pins (also not shown) that engage with holes (also not shown) in end piece 22 or other means of locking the front wall with respect to the end piece to allow for transport and temporary storage of refuse within the container. Rear wall 38 of preferred container 16 is provided with an opening and a sweep panel 46 that is pivotally attached at the top of the end wall along pivot axis 47 (FIG. 4). As illustrated in FIGS. 4 and 5, the sweep panel is movable between an open position which exposes the opening in the rear wall (FIG. 4) and a closed position which covers the opening in the rear wall (FIG. 5). Preferably, the rear wall is also provided with fixed dam 48 in order to minimize the risk that liquids will spill out of the container when it is being used to transport or store refuse. The sweep panel is also preferably adapted to be fixed in place in its closed position (shown in FIG. 5) by pins (not shown) which may be pneumatically actuated to engage holes 50 (only one of which is shown in FIG. 4) on opposite sides of the sweep panel. Opening of sweep panel (as hereinafter explained in more detail), as shown in FIG. 4, will expose the opening therebeneath (and above dam 48) through which refuse may be placed into the container.

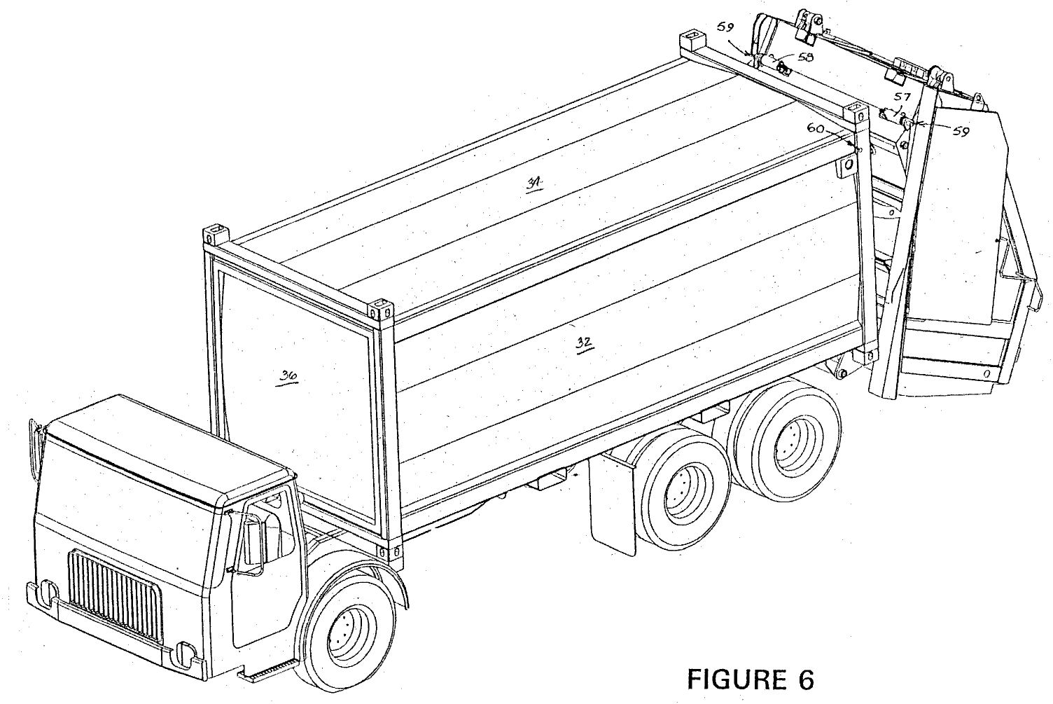

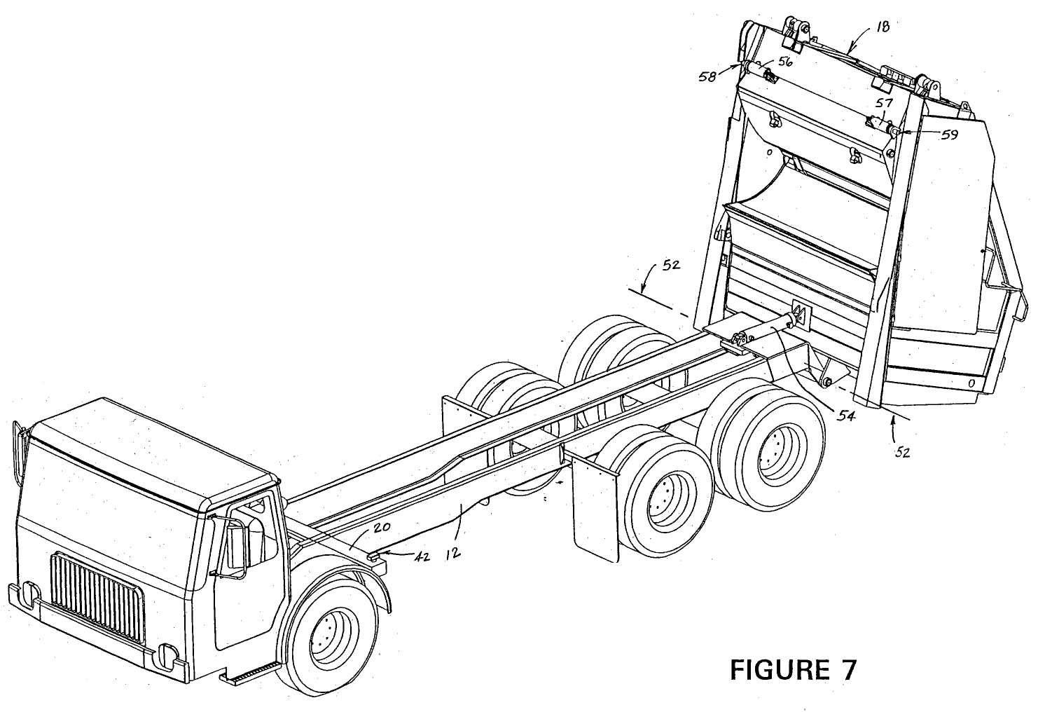

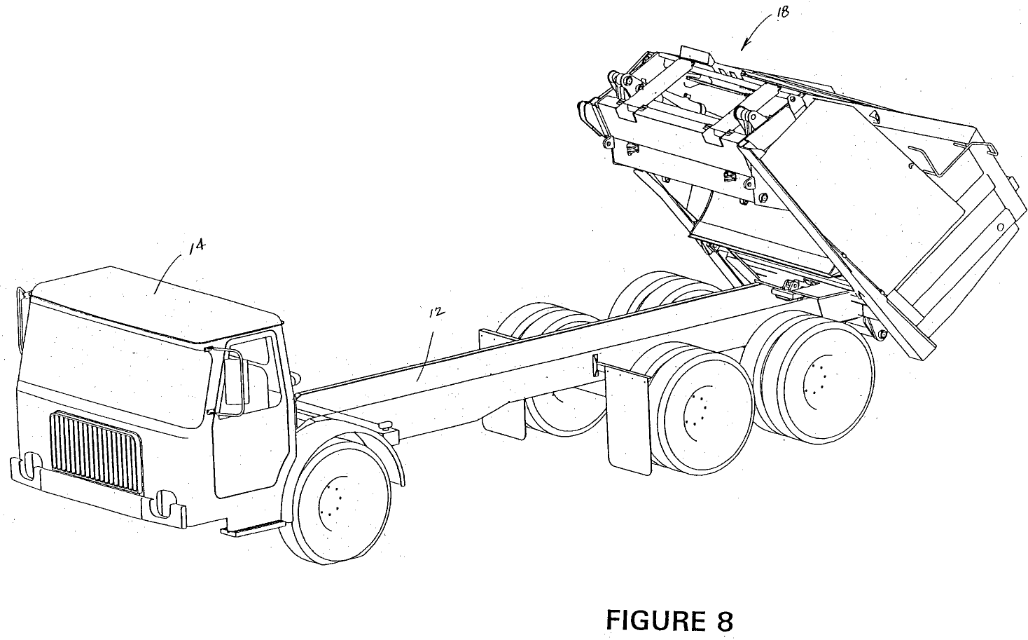

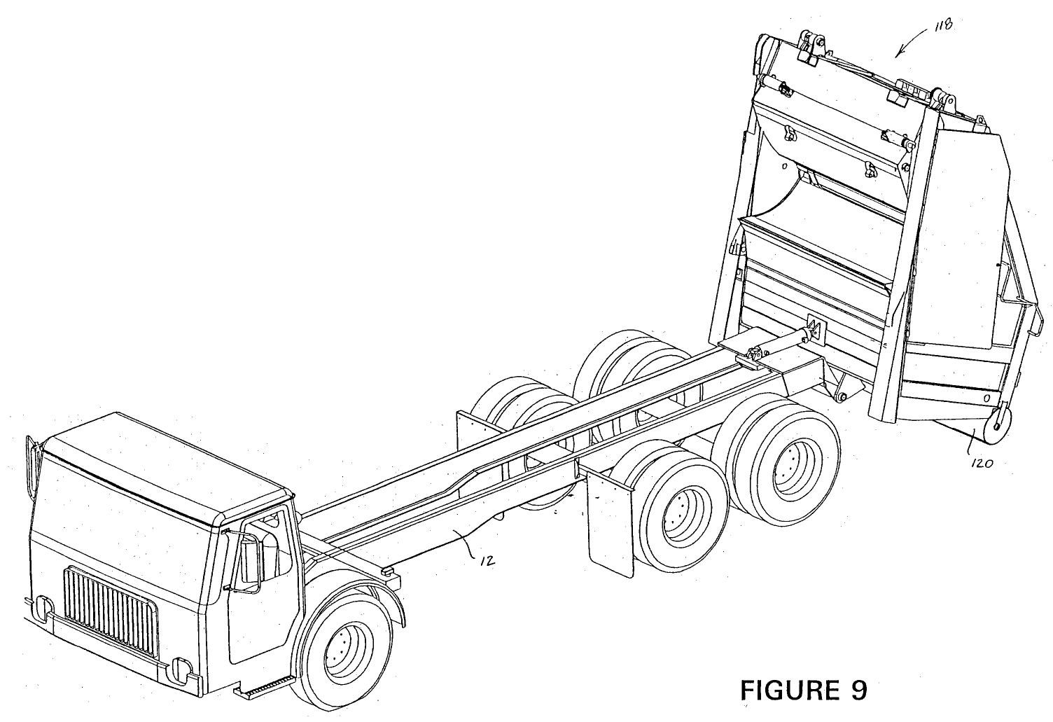

As best shown in FIG. 7, preferred tailgate assembly 18 is pivotally mounted to chassis 12 along pivot axis 52. Hydraulic actuator 54 is also preferably attached between chassis 12 and the tailgate assembly and is adapted to pivot the tailgate assembly so as to permit container 16 to be removed from the vehicle, as shown in FIG. 6. With the container removed, the tailgate assembly may be tilted forward for travel, as shown in FIG. 8. In an alternative embodiment illustrated in FIG. 9, tailgate 118, identical to tailgate 18 except for the addition of roller 120, may be tilted rearwardly so that roller 120, or a similar wheeled structure, may rest on and roll along the road surface for travel with the container removed. As shown in FIGS. 6 and 7, preferred tailgate assembly 18 includes locking mechanisms for attaching the tailgate assembly to the container. The preferred locking mechanisms are a pair of hydraulic actuators 56 and 57, which are adapted to engage pins 58 and 59 into holes (only one of which, hole 60, is shown in FIG. 6) in end piece 24 of container 16.

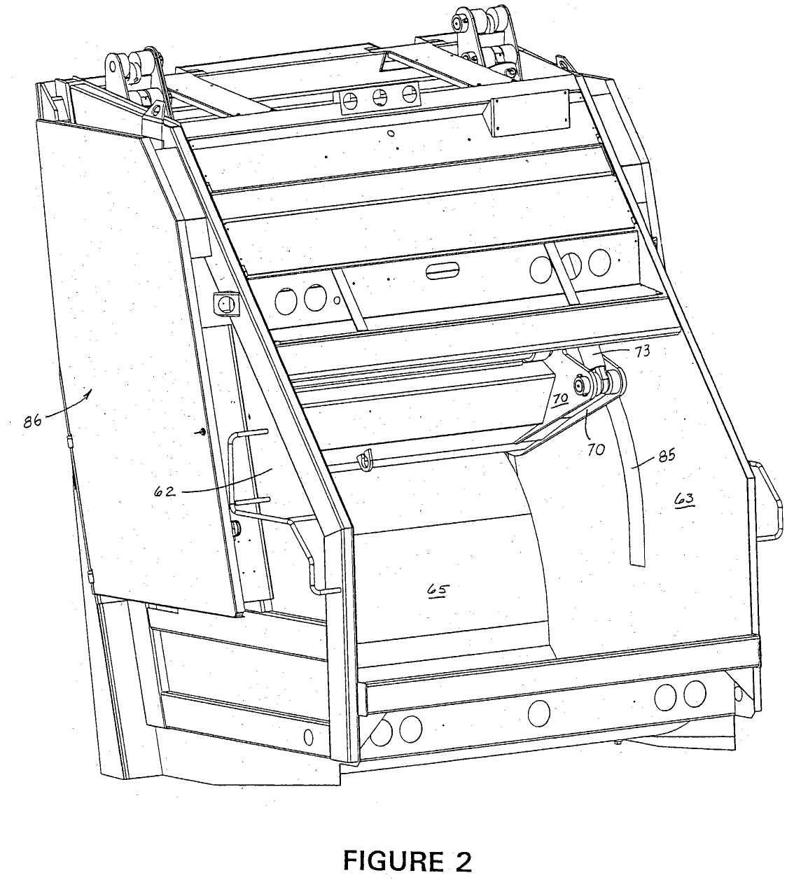

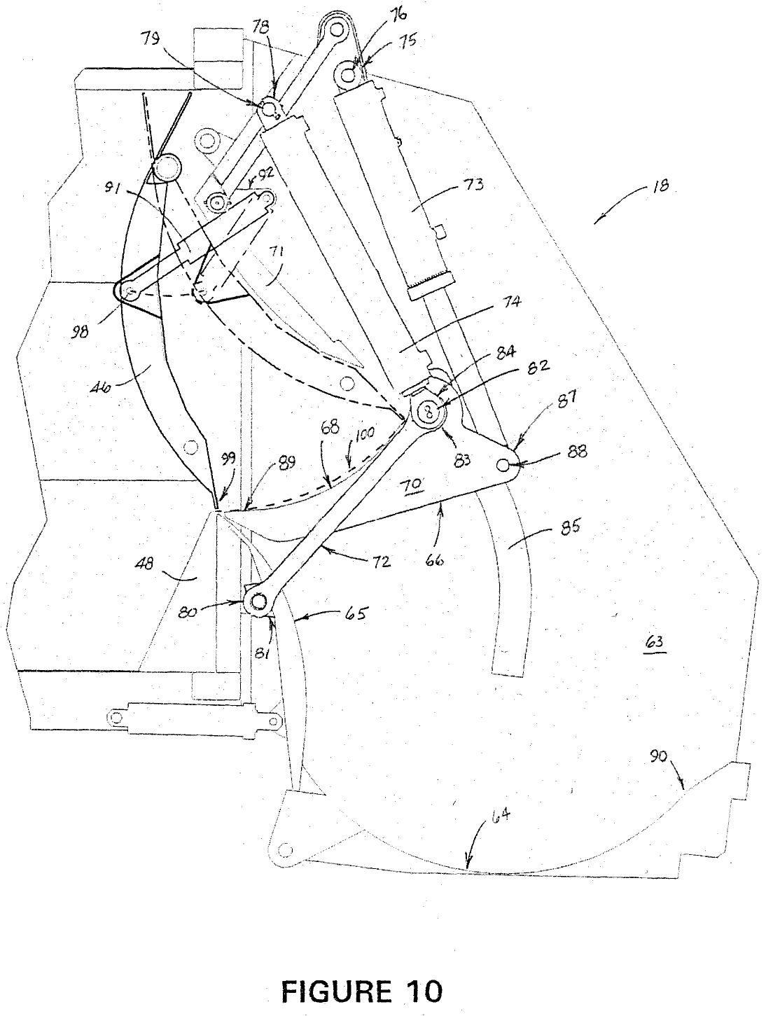

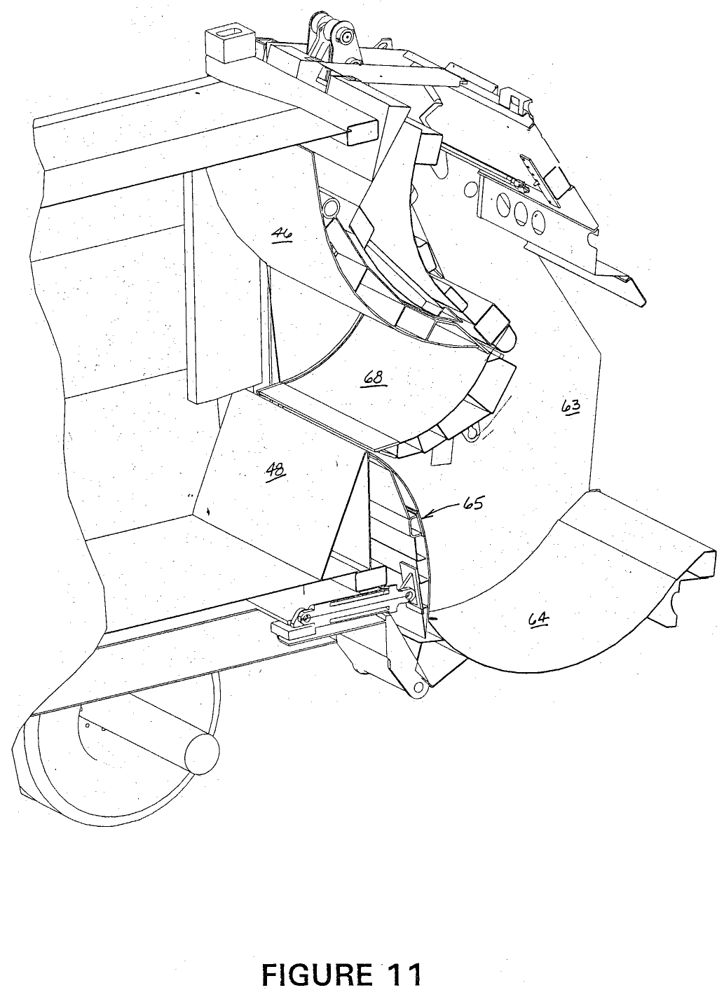

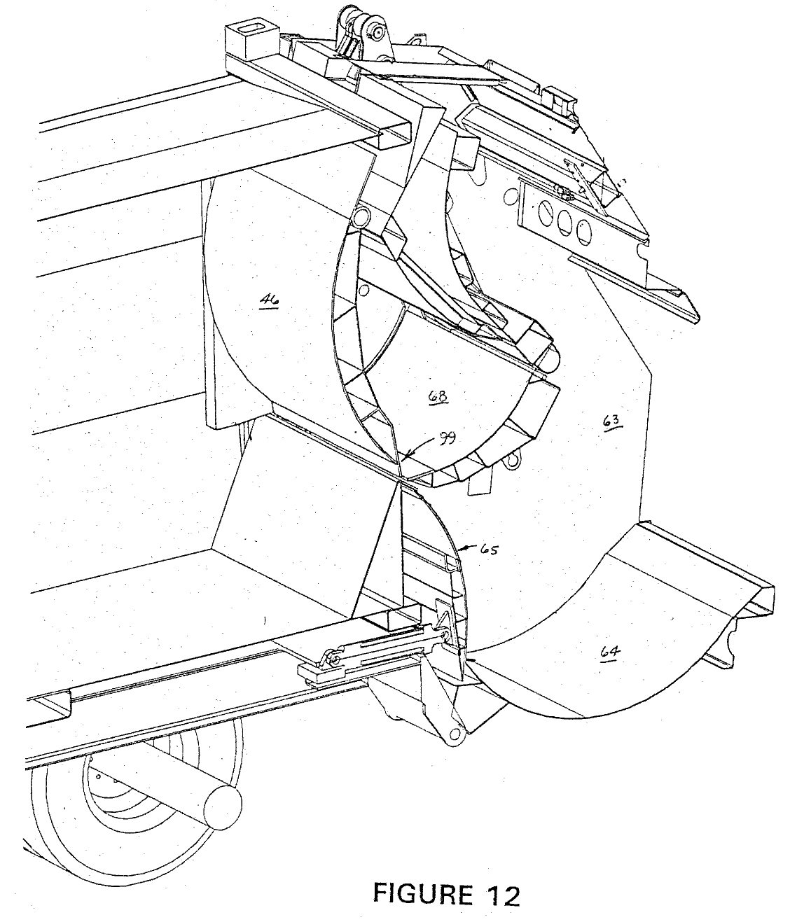

Referring now to FIGS. 1, 2 and 10-12, tailgate 18 includes a hopper into which refuse may be deposited from the rear of vehicle 10. The hopper is defined by tailgate sidewalls 62 and 63, hopper floor 64 and front plate 65. The front plate preferably extends in an arcuate configuration to the top of dam 48 on rear wall 38 (see FIG. 5) of container 16. The tailgate assembly includes a packer 66 (best illustrated in FIG. 10) comprised of packer panel 68 and a plurality of packer end plates 70 (only one of which is shown in FIG. 10). The tailgate assembly also includes fixed deflector plate 71, a pair of links 72 (only one of which is shown in FIG. 10), a first pair of hydraulic actuators 73 (only one of which is shown in FIG. 10) and a second pair of hydraulic actuators 74 (only one of which is shown in FIG. 10). The base end 75 of actuator 73 is preferably pivotally attached to the inside of a tailgate sidewall at pivot mount 76, and the base end 78 of actuator 74 is preferably pivotally attached to the outside of a tailgate sidewall at pivot mount 79. Each of links 72 is preferably pivotally attached at a first end 80 to an extension bracket 81 of the tailgate assembly that is located adjacent to or in front of front plate 65. A pair of link pins 82 (only one of which is shown in FIG. 10) are also provided to connect each of links 72 at its second end 83 to the extension end 84 of one of actuators 74. As shown in FIG. 10, each link pin extends through a packer end plate 70 at an intermediate position, through the second end of link 72 and the extension end of actuator 74, and through curved slot 85 in the sidewall of the tailgate assembly. The links 72 and hydraulic actuators 74 attached thereto are located within exterior enclosure 86 (one of which is shown in FIG. 2). The extension end 87 of each of actuators 73 is preferably attached to packer end plate 70 at rear end pivot point 88. The configuration of packer 66 and the cooperation of link 72, link pin 82 and slot 85, along with the action of actuators 73 and 74, defines the motion of packer panel 68 within the tailgate assembly. Referring now to FIGS. 2, 10 and 11, it can be appreciated that if actuator 74 were extended and actuator 73 retracted, packer panel 68 would be open so that front end 89 would be located at the rear end 90 of hopper floor 64. Extension of actuator 73 would then cause front end 89 of packer panel 68 to follow the contours of hopper floor 64 to its intersection with front plate 65, sweeping any refuse in the hopper before it. Retraction of actuator 74 will then cause front end 89 of packer panel 68 to follow the contours of front plate 65, carrying refuse from the hopper up to and through the opening in the container created by the opening of sweep panel 46 (see also FIG. 11). In the preferred embodiment of the invention, one end of each of a pair of hydraulic actuators (one of which, actuator 91, is shown in FIG. 10) is connected to bracket 92, preferably by a trunnion mount, that is attached to fixed deflector plate 71. The other ends of the actuators are attached to sweep panel 46 by a pair of pneumatic cylinders 93 and 94 (FIGS. 4 and 5), which are adapted to engage pins 96 and 97 into holes (only one of which, hole 98, is shown in FIG. 10) in the ends of the hydraulic actuators. As understood by comparing FIGS. 11 and 12 and the representations of sweep panel 46 in solid lines and dashed lines in FIG. 10, extension of the hydraulic actuators attached to sweep panel 46 will cause the sweep panel to move from the open position of FIG. 11 (corresponding to the representation of sweep panel 46 in dashed lines in FIG. 10) to the closed position of FIG. 12 (corresponding to the representation of sweep panel 46 in solid lines in FIG. 10). As the actuators are extended, lower end 99 of panel 46 will follow the contours of packer panel 68 (corresponding to dashed line 100 of FIG. 10) and sweep any refuse material retained thereon into the container. Thus, the arrangement and configuration of the preferred sweep panel and packer assembly results in cooperation between the sweep panel and the packer assembly as the sweep panel is moved from the open position to the closed position to substantially eliminate or minimize the spilling of refuse material from the opening of the storage container into the hopper. The action of the sweep panel in sweeping across the packer panel will also assist in packing refuse in the container, and it will serve to close off the container so that it may be removed from vehicle 10.

Preferably, the actuators attached to the sweep panel are double acting hydraulic actuators which are adapted to move the sweep panel between the open and the closed positions illustrated by FIGS. 11 and 12. However, it is also contemplated that other mechanical actuators could be employed to move the sweep panel between the open and closed positions. Thus, for example, a motor (not shown) could be provided to move the sweep panel between the open and closed positions. The sweep panel could also be mounted on a shaft along axis 47 (FIG. 4) having a torsion spring thereon that is adapted to hold the sweep panel in either the open or the closed position. A motor, single acting hydraulic actuator, lever or ratcheted gear system could be employed to move the sweep panel against the action of the torsion spring.

It is also contemplated within the scope of the invention that the various hydraulic actuators employed in the packer assembly of the invention could be replaced by pneumatic actuators, motorized drives or other mechanical actuators for moving the packing panel within the hopper. Similarly, it is contemplated within the scope of the invention that the various pneumatic actuators employed in the invention could be replaced by hydraulic actuators, spring loaded pins or other mechanical actuators for engaging pins with corresponding holes.

Although this description contains many specifics, these should not be construed as limiting the scope of the invention but as merely providing illustrations of some of the presently preferred embodiments thereof, as well as the best mode contemplated by the inventors of carrying out the invention. The invention, as described herein, is susceptible to various modifications and adaptations, as would be understood by those having ordinary skill in the art to which the invention relates, and the same are intended to be comprehended within the meaning and range of equivalents of the appended claims.

What is claimed is:

1. A refuse collection vehicle comprising:
(a) a chassis;
(b) a storage container that is detachably mounted on the chassis, said storage container having a rear wall with an opening therein and a sweep panel that is pivotally mounted in the rear wall, said sweep panel being movable between an open position which exposes the opening in the rear wall of the container and a closed position which covers the opening in the rear wall of the container;
(c) a rear tailgate assembly that is pivotally mounted to the chassis, said tailgate assembly having a hopper which is adapted to receive refuse and a packer assembly which is adapted to move refuse from the hopper of the tailgate assembly to the opening in the rear wall of the storage container when the sweep panel of the storage container is in the open position;
wherein the sweep panel and the tailgate assembly are arranged and configured so as to minimize the spilling of refuse from the opening of the storage container into the hopper as the sweep panel is moved from the open position to the closed position.

2. The refuse collection vehicle of claim 1 which includes an actuator for moving the sweep panel between the open position and the closed position.

3. The refuse collection vehicle of claim 1 wherein the tailgate assembly includes a locking mechanism for attaching the tailgate assembly to the container.

4. The refuse collection vehicle of claim 1 wherein the container includes a dam in the rear wall below the sweep panel.

5. The refuse collection vehicle of claim 1 wherein:
(a) the hopper of the tailgate assembly includes a hopper floor;
(b) the packer assembly includes a packer having a packer panel, which packer is adapted to move across the hopper floor to move refuse to the opening in the rear wall of the storage container when the sweep panel is in the open position;
(c) the sweep panel has a lower end;
(d) the sweep panel and packer assembly are arranged and configured so that movement of the sweep panel from the open to the closed position after the packer has moved refuse to the opening in the rear wall of the storage container will move the lower end of the sweep panel across the packer panel to sweep refuse into the container.

6. The refuse collection vehicle of claim 1 wherein an actuator is attached between the chassis and the tailgate assembly, which actuator is adapted to pivot the tailgate assembly to permit the container to be removed from the vehicle.

7. The refuse collection vehicle of claim 6 wherein the actuator that is attached between the chassis and the tailgate assembly is also adapted to pivot the tailgate assembly forward when the container is removed.

8. The refuse collection vehicle of claim 6 wherein:
(a) the tailgate assembly includes a roller that is adapted to support the tailgate assembly when the tailgate assembly is pivoted rearwardly; and
(b) the actuator that is attached between the chassis and the tailgate assembly is also adapted to pivot the tailgate assembly rearward when the container is removed, so that the tailgate assembly may be supported by the roller.

9. The refuse collection vehicle of claim 1 wherein the storage container includes a pair of container sidewalls, a top wall, a bottom wall and a front wall, in addition to the rear wall.

10. The refuse collection vehicle of claim 9 wherein the front wall of the storage container is hinged at the top.

11. The refuse collection vehicle of claim 1 wherein the chassis includes a cross-member for supporting the container.

12. The refuse collection vehicle of claim 11 wherein:
(a) the cross-member includes a lock at each end thereof; and
(b) the container includes a pair of corner castings that are adapted to receive the locks on the cross-members to secure the container on the chassis.

13. A refuse collection vehicle comprising:
(a) a chassis;
(b) a storage container that is detachably mounted on the chassis, said storage container having a rear wall with an opening therein and a sweep panel that is pivotally mounted in the rear wall, said sweep panel being movable between an open position which exposes the opening in the rear wall of the container and a closed position which covers the opening in the rear wall of the container;
(c) a rear tailgate assembly that is pivotally mounted to the chassis, said tailgate assembly comprising:
(i) an actuator for moving the sweep panel between the open position and the closed position;
(ii) a hopper which is adapted to receive refuse, said hopper being defined by a pair of tailgate sidewalls with a front plate and a hopper floor extending between the sidewalls, with each of said sidewalls having a curved slot extending therethrough;
(iii) a packer assembly which comprises:
(a) a packer comprised of a packer panel and a plurality of packer end plates, with each of said packer end plates having a front end and a rear end;
(b) a first pair of actuators, each of which has a base end and an extension end, wherein the base end of each of said first pair of actuators is pivotally attached to the inside of a tailgate sidewall, and wherein the extension end of each of said first pair of actuators is pivotally attached to the rear end of a packer end plate;
(c) a second pair of actuators, each of which has a base end and an extension end, wherein the base end of each of said second pair of actuators is pivotally attached to the outside of a tailgate sidewall;
(d) a pair of links, each of which has a first end and a second end, wherein each link is pivotally attached at its first end adjacent to the front plate and each link is pivotally attached at its second end to the extension end of one of the second pair of actuators;
(e) a pair of link pins, each of which extends through the packer end plate at an intermediate position, connects the second end of a link to the extension end of one of the second pair of actuators and extends through the curved slot in an adjacent sidewall;
wherein the packer assembly is adapted to move refuse from the hopper of the tailgate assembly to the opening in the rear wall of the storage container when the sweep panel of the storage container is in the open position.

14. The refuse collection vehicle of claim 13 wherein the container includes a dam in the rear wall below the sweep panel.

15. The refuse collection vehicle of claim 13 which includes a pair of exterior enclosures, each of which is located outside a sidewall of the hopper, and each of which encloses one of the pair of links and one of the pair of second actuators.

16. The refuse collection vehicle of claim 13 wherein the tailgate assembly includes a fixed deflector plate that is located in front of the second pair of actuators.

17. The refuse collection vehicle of claim 16 which includes:
(a) a bracket that is mounted on the fixed deflector plate; and
(b) an actuator, one end of which is connected to the bracket and the other end of which is connected to the sweep panel, which actuator is adapted to move the sweep panel between the closed position and the open position.

18. The refuse collection vehicle of claim 13 wherein the chassis includes a cross-member for supporting the container.

19. The refuse collection vehicle of claim 18 wherein:
(a) the cross-member includes a lock at each end thereof; and
(b) the container includes a pair of corner castings that are adapted to receive the locks on the cross-members to secure the container on the chassis.
